(19) United States
(12) Patent Application Publication
(10) Pub. No.: US 2003/0045412 A1
(43) Pub. Date: Mar. 6, 2003

(54) Laser engraved embossing roll with wear-resistant coatings and method of making them

(76) Inventors: Galyn A. Schulz, Greenville, WI (US); William T. Buchholz, Greenville, WI (US); Jean Rasmussen, Besigheim (DE)

Correspondence Address: Finnegan, Henderson, Farabow,, Garrett & Dunner, L.L.P., 1300 I Street, N.W., Washington, DC, 20005-3315, US

(21) Appl. No.: 10/187,608

(22) Filed: Jul. 3, 2002

Related U.S. Application Data
(60) Provisional application No. 60/304,766, filed on Jul. 13, 2001.
(60) Provisional application No. 60/372,418, filed on Apr. 16, 2002.

(51) Int. Cl. B29C 33/40; B29C 59/00; B21D 53/00

(52) U.S. Cl. 492/30; 264/400; 264/129; 264/219; 492/48; 29/895.3; 29/895.32

(57) ABSTRACT

The present invention relates to an embossing roll for embossing running webs of material and a method of making that roll. More particularly, the present invention is an embossing roll of a hard elastomer surface that can be engraved and subsequently plated to form a protective wear-resistant surface.

### PRIORITY CLAIM

This application claims the benefit of U.S. Provisional Application No. 60/304,766, filed Jul. 13, 2001, and U.S. Provisional Application No. 60,372,418, filed Apr. 16, 2002, both of which are incorporated herein by reference.

### FIELD OF THE INVENTION

The present invention relates to an emboss roll for continuously embossing a moving web of material such as paper. More particularly, the present invention relates to a roll that is surface treated to improve wear-resistance and roll life. Still more particularly, the present invention relates to a patterned roll having a metal coating. The present invention further relates to a method for making the emboss roll of the present invention through patterning by laser engraving. Finally, the present invention relates to a method of embossing a moving web using the embossing roll of the present invention.

### BACKGROUND OF THE INVENTION

The present invention relates to apparatus used to emboss paper products, preferably elongate webs used to make paper goods, e.g., paper towels, toilet tissue, or paper napkins. Embossing is the act of mechanically working a substrate to cause the substrate to conform under pressure to the depths and contours of a patterned embossing roll. Generally, the web is passed between a pair of emboss rolls that, under pressure, form contours within the surface of the paper.

In most configurations at least one of the two roller surfaces directly carries the pattern to be transferred to the paper web. Known configurations include rigid-to-resilient embossing and rigid-to-rigid embossing. The present invention is an improved embossing roll for use in any known embossing configuration.

In a rigid-to-resilient embossing system, a single or multi-ply substrate is passed through a nip formed between a roll whose substantially rigid surface contains the embossing pattern as a multiplicity of protuberances and/or depressions arranged into an aesthetically-pleasing manner, and a second roll, whose substantially resilient surface can be either smooth or also contain a multiplicity of protuberances and/or depressions which cooperate with the rigid surfaced patterned roll. Heretofore, rigid rolls were generally formed from a steel body which is either directly engraved upon or which can contain a hard elastomeric surface (directly coated or sleeved) upon which the embossing pattern is laser engraved. While a steel roll that has been directly engraved has a longer lifespan, the production of a directly engraved steel roll can require a significant lead time. Known laser engraved sleeves can take less time to make but have a lifespan which is substantially less than that of a steel roll.

Resilient rolls may consist of a steel core directly coated or sleeved with a resilient material and may or may not be engraved with a pattern. If a pattern is present, it may be either a mated or a non-mated pattern with respect to the pattern carried on the rigid roll.

In the rigid-to-rigid embossing process, a single-ply or multi-ply substrate is passed through a nip formed between two substantially rigid rolls. The surfaces of both rolls contain the pattern to be embossed as a multiplicity of protuberances and/or depressions arranged into an aesthetically-pleasing manner where the protuberances and/or depression in the second roll cooperate with those patterned in the first rigid roll. The first rigid roll is generally formed from a steel body which is either directly engraved upon or which can carry a hard elastomeric surface (directly coated or sleeved) upon which the embossing pattern is laser engraved. The second rigid roll is generally formed from a steel body which is also directly engraved upon or which can carry a hard elastomeric surface (directly coated or sleeved) upon which a matching or mated pattern is conventionally engraved or laser engraved. Laser engravable rolls are known, see for example U.S. Pat. Nos. 4,211,743 and 5,356,364, both of which are incorporated herein by reference, in their entirety.

Prior art embossing systems where the embossing pattern is carried directly by one or both of the steel embossing rolls suffer from a number of disadvantages. Specifically, to directly engrave steel can require a significant amount of lead time. Laser engraving of hard elastomeric surface materials has improved the lead time, but has not replaced directly engraved steel rolls due to issues associated with wear. Furthermore, directly engraved steel rolls run the risk that if the emboss pattern gets damaged and a new roll must be produced, the preparation of a new steel roll can require significant time, possibly resulting in machine down time and definitely resulting in increased expense.

The present invention solves the problems associated with the prior art by providing a surface that can be patterned by a method which requires significantly less lead time than physically engraving a steel roll. This method thereby reduces the amount of time necessary to get a product into production, but nonetheless presents a surface that will wear well under standard embossing conditions. The rolls of the present invention provide a sufficiently long life to overcome the disadvantages associated with prior laser engraved hard elastomeric rolls.

### SUMMARY OF THE INVENTION

In accordance with the invention, there is disclosed an embossing roll comprising, a structurally rigid core, a patterned laser engravable material and a wear-resistant coating or material over said core.

There is further disclosed an embossing roll comprising, a core; a patterned laser engravable material surrounding said core; and a wear-resistant coating surrounding said patterned laser engravable material.

There is still further disclosed a method of making an embossing roll comprising, providing a structurally rigid core; providing a laser engravable surface; patterning said laser engravable surface with an embossing pattern; and providing a wear-resistant material over said laser engravable surface.

There is disclosed a method of making an embossing roll comprising, providing a core; surrounding said core with a laser engravable material; patterning said laser engravable material with an embossing pattern; and plating said patterned core with a metallic wear-resistant material.

Finally, there is disclosed a method of embossing a paper web comprising, passing the web between two embossing rolls, at least one of which contains a laser engraved pattern and a wear-resistant coating over said laser engraved pattern.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiments of the invention and together with the description, serve to explain the principles of the invention.

### BRIEF DESCRIPTION OF THE DRAWINGS

FIG. 1 illustrates an emboss roll according to the present invention.

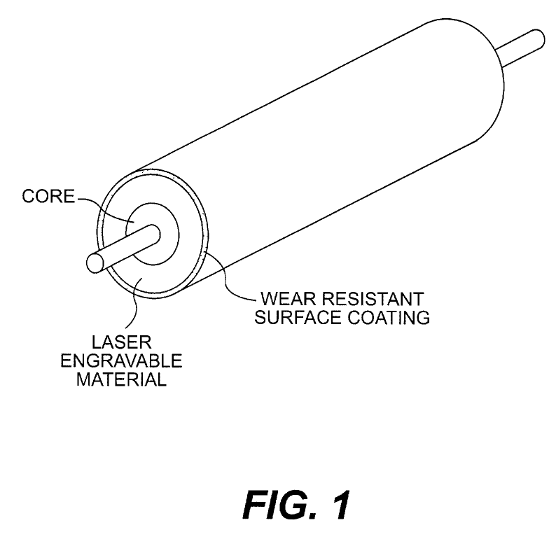

FIG. 2 graphically represents the wear versus hardness for a variety of wear-resistant coating materials.

### DESCRIPTION OF THE EMBODIMENTS

The present invention relates to the production of rolls for use in the embossing of elongate webs of material, such as paper and the like. More specifically, the present invention relates to embossing rolls that have improved wear resistance surfaces.

The embossing roll according to the present invention can be either a single laser engravable material upon which an embossing pattern is engraved or can be a rigid core that is coated or sleeved. Selection between the foregoing embodiments will depend upon the structural rigidity of the laser engravable material. The central core of the roll should have sufficient structural rigidity to withstand normal pressures associated with embossing webs in a commercial setting.

One advantage associated with the present invention is the improvements in production time that may be achieved when the embossing pattern may be created using laser engraving. As described above, the pattern can be carried directly by a core material that can be laser engraved or can be present in a sleeve or coating of laser engravable material that surrounds a structurally rigid core.

The core may be produced from any art recognized material which can be sleeved or coated with a laser engravable material. Appropriate materials to produce a structurally rigid core include, but are not limited to, steel, chrome, nickel, aluminum, ceramics and mixtures thereof. Appropriate methods for forming a patternable coating or sleeve over a rigid core include any art recognized method and would be readily apparent to the skilled artisan. Preferred coating methods include dip coating, casting or vulcanizing. Appropriate core preparation may include pretreatment to achieve the necessary adherence between the core and the coating. Pretreatments may include, but are not limited to, mechanical pretreatment like sandblasting, grind blasting or sanding, or chemical pretreatment in strong oxidative acidic solutions.

Laser engravable materials include all materials which, in solid form, will evaporate at temperatures delivered by the laser source. Appropriate laser engravable materials which are strong enough to withstand the pressures of high speed engraving include, but are not limited to rubbers, silicone rubber, nylon, polyesters, polyurethane, polytetrafluoroethylene, polyvinylidene fluoride co-hexafluoropropylene, nitrile rubbers, and ebonite. Preferred laser engravable materials are commercially available under the names PREMIUM ROCK™ and VAL-COAT PLUS™.

Other patternable materials that may be used with the present invention include resins. While resins have not generally been used for embossing rolls, resins provide good durability, good castability, good core adhesion, good printability and good engravability. Appropriate resins would include, but are not limited to, epoxy resins, particularly bisphenol type epoxy resins, phenolic resins, polyester resins, thermosetting resins, and polycarbonate resins. Preferred resins are available under the tradename TOP ROCK™. Resin materials for use in the present invention may be filled or unfilled materials. The resin may include up to 50% filler. Appropriate resins will be readily apparent to the skilled artisan and their selection may be based upon cost, engravability, durability and metallizability.

Still other patternable materials that may be used with the present invention include metals. Laser engravable metals, include, but are not limited to aluminum, including cast aluminum; brass; bronze; nickel; chrome; cast iron; steel, including untreated and stainless steel; zinc; tin; alloys; and mixtures thereof.

In one embodiment of the invention, the laser engravable roll may be a fiber roll. Fiber rolls are well known in the industry and when used as embossing rolls they are generally patterned by the pressure of being run against a patterned steel embossing roll. The term fiber encompasses any art recognized fibrous materials including, but not limited to, cotton, felt, paper, and latex impregnated versions of these fibrous materials. According to the present invention, the surface of the fiber roll would be laser engraved with a pattern and then coated with a wear-resistant coating.

The embossing rolls according to the present invention further include a wear-resistant coating. Wear resistance as used in the present invention refers to a coating which improves the wear characteristics of the underlying laser engravable material. The harder a material is the better the wear resistance of that material. Roll wear-resistance can be expressed according to the International Standard (ISO) ISO-8251, “Measurement of Wear Resistance and Wear Index of Anodic Oxidation Coatings with an Abrasive Wheel,” which is incorporated herein by reference.

One method for selecting appropriate wear-resistant materials for use in the present invention is based upon ISO-8251. Wear test performance is generally dependant upon the load size of the abrasive force, the mesh size of the abrasive tape and the surface topography of the samples tested. Weight calculated as loss per 1000 double strokes after 1200 strokes according to ISO 8251 using a load size of 4.9N (500 g) and an abrasive tape of silicon carbide mesh 320 can be used as criteria for selecting elastomeric materials and metallic coatings suitable for use in the present invention. Preferred materials exhibit a maximum weight loss of less than about 100 mg/1000 double strokes, more preferably, preferred materials exhibit a weight loss of less than about 80 mg/1000 double strokes, and most preferably, preferred materials exhibit a weight loss of less than about 60 mg/1000 double strokes.

Appropriate materials are those that can provide wear resistance and include, but are not limited to, nickel, chrome, steel, titanium, aluminum, Teflon, carbide, nitride, diamonds, indium, phosphor, molybdenum sulfide, alloys and mixtures thereof. Preferred wear-resistant coating materials are selected from nickel, chrome, steel and mixtures thereof. The harder the wear-resistant coating material, the better the wear characteristics of the material. Appropriate selection may be based upon a number of factors which can include the increases in cost often associated with increases in hardness or the increases in cost associated with the complexity of the method of forming the wear-resistant coating.

One or more wear-resistant layers may make up a wear-resistant coating. Appropriate wear-resistant layers can be applied individually, sequentially or simultaneously and may be made of the same or different materials. Preferred combinations of materials for use in sequential application include, but are not limited to, nickel and chrome, nickel and steel, nickel and nitride, chrome and steel, ceramic and steel, ceramic and nickel, nickel and Teflon, nickel and diamond, nickel and carbide, nickel and phosphor, and nickel and indium.

The wear-resistant coating may be applied using any art recognized method. Appropriate methods would include, auto catalytic plating, electro-deposition, physical coating by rotation metallization such as sputtering or e-beam deposition, pressure vapor deposition, chemical vapor deposition and laser induced deposition.

Any art recognized method or after developed method for applying the wear-resistant coating to the surface of the pattern emboss roll is within the scope or the present invention. As an alternative to plating or coating the wear-resistant coating onto the roll, the wear-resistant coating may be coated, for example, onto the interior of a patterned mold by for example, vapor deposition techniques. The roll material, e.g. an elastomeric material, for example, rubber, would then be charged to the mold and when the mold was released, a roll having a wear-resistant coating would result. In this embodiment of the present invention, a structurally rigid core may also be used.

The wear-resistant coating and the laser engravable material must be sufficiently adhesive to maintain the coating without release, preferably under commercial embossing conditions. Appropriate wear-resistant coatings may have a depth of from about 2.5 microns to about 250 microns, more preferably from about 12 microns to about 125 microns, and most preferably from about 25 microns to about 50 microns.

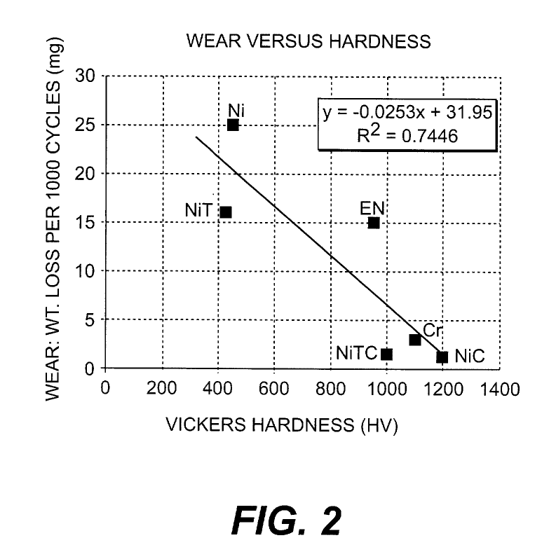

FIG. 2 provides wear vs. hardness data for a variety of materials. The wear data presented in FIG. 2 is Taber wear data. The Taber wear test is a standardized method for evaluation of abrasive wear of solid materials. A panel is rotated in contact with two roller bearing supported wheels. Due to an offset between disc center and the grinding wheel center, an abrasive contact situation is developed as the grinding wheels co-rotate. The wheels are held under a constant load (for example 10N). The rubber wheels are filled with aluminum oxide particles, e.g., abrasive grade type CS10 and CS17. The selected number of cycles (disc rotations) is carried out, typically 12,000 cycles, and the weight loss of the material test is then measured. Wear is calculated as mg loss per 1000 cycles. The data is provided for electroplated Nickel (Ni), electroless nickel (EN), electroless Nickel/Teflon (NiT), electroplated hard chrome (Cr), electroless Nickel/Carbide (NiC), and electroless Nickel/Carbide/Teflon (NiTC).

Embossing patterns for use with the roll according to the present invention include any art recognized embossing pattern. More particularly, embossing patterns for use with the present invention include those appropriate for use in the embossing of absorbent paper products such as tissue and towel. Any previously known or after developed emboss pattern that is capable of being laser engraved can be used with the emboss roll of the present invention. Appropriate patterns will be readily apparent to the skilled artisan. Preferred patterns include microemboss patterns, macroemboss patterns, signature elements, spot emboss elements, and elongate embossing elements.

When producing a pattern that will have a wear-resistant surface coating, the dimensions of the pattern may need to be manipulated to account for the expected wear-resistant coating to thus assure that the final pattern will have the desired dimensions. Such pattern manipulation, often in the form of reductions of the element size (male bosses) or increases in the element size (female bosses) would be readily apparent to the skilled artisan. Appropriate changes would preserve the originally desired element sizes after application of the wear-resistant material.

The embossing pattern may be applied to the patternable material using any art recognized technique including laser engraving, patterning using solid state techniques, or chemical etching. Preferred solid states techniques would include photoresist patterning, preferably followed by chemical etching. In another preferred embodiment, the patternable material is laser engraved with the desired embossing pattern.

The wear-resistant embossing rolls of the present invention may be used with any known embossing configuration including nested, off-nested and point-to-point configurations. Off-nested configurations are shown in U.S. Pat. No.5,356,364.

The coating may require the use of additional agents that promote the adherence or release of the wear-resistant coating to the laser engravable materials. Further, the wear-resistant coating may include wear modifiers, such as silicates, carbides, nitrides, titanium based modifiers, diamond, Teflon, phosphor, indium and molybdenum sulfide. The appropriate selection of wear modifiers is based upon the cost and performance of the various additives, as well as any effect of the additive on the properties of the primary wear-resistant coating. The selection of appropriate additives would be readily apparent to the skilled artisan.

In some embodiments it may be necessary to use a primer or binding coating. Appropriate primer and binding coatings would be readily apparent to the skilled artisan and include any materials which improve the adhesion between the laser engravable material of the roll and the wear-resistant coating material.

The present invention can also be used to refurbish embossing rolls that have prior wear-resistant coatings. Without the need to produce new embossing rolls, as the wear-resistant coating begins to show signs of wear, the roll can be removed from the embossing apparatus and stripped of the wear-resistant coating. The underlying engraving pattern will not be harmed by such a stripping operation and the roll may be recoated with a fresh wear-resistant coating. Appropriate stripping methods will be readily apparent to the skilled artisan based upon the material of the wear-resistant coating that is to be removed.

When a metal roll surface is used, any wear resistant coating can be removed, for example, by chemical stripping. Once the wear resistant coating has been removed, the metal roll surface can be mechanically treated to remove the outermost surface and then the roll can be polished. The polished roll is then ready, for example, to be plated to restore the original metal surface thickness. The roll can then be again patterned and coated with another wear resistant surface, if necessary.

In a preferred embodiment according to the present invention, chrome can be stripped using, for example, hydrochloric acid at 50° C. or with a solution of sodium hydroxide and sodium carbonate at room temperature. In an alternate embodiment, nickel can be removed using either nitric acid or a combination of sodium hydroxide, ethylenediamine and m-nitrobenzene sulfonic acid. The selection of appropriate stripping solutions would be readily apparent to the skilled artisan.

In one preferred embodiment of the present invention, the wear-resistant coating is applied to the surface of the roll through a metal plating process. The times, temperatures and chemicals used in the various process steps of the plating process are selected based upon the composition of the patternable material and the composition of the wear-resistant material to be applied. In the following discussion, preferred processing conditions based upon material are noted where appropriate. The skilled artisan can select appropriate plating conditions based upon known techniques for plating of non-conductive surfaces.

Prior to providing the wear-resistant coating, the roll may be cleaned to remove any residues and to prepare the surface for the wear-resistant coating. A clean surface improves the adhesion of the wear-resistant coating. Cleaning solvents for use in the present invention include, but are not limited to, acetone, methanol, ethanol, as well as other commercially available inorganic alkaline neutral and acidic cleaners and mixtures thereof. Cleaning is preferably carried out for a time of from about 1 mins to about 30 mins, more preferably from about 2 mins to about 20 mins, and most preferably from about 5 mins to about 15 mins.

After cleaning, the patterned surface of the roll can be further surface treated to promote adhesion between the patterned material and the wear-resistant surface coating. When surface preparation is used, it is appropriate to use more than one roughening technique such as sand paper roughening followed by chemical etching; however, it is not necessary to use more than a single preparation technique. Appropriate pretreatment techniques include, but are not limited to, one or more of physical roughening, by for example, blasting, sanding, brushing and the like, or by chemical pretreatment, by for example, immersion in acid etching solutions.

Appropriate etching solutions are selected from highly oxidizing solutions. Preferred etchants are preferably selected from chromic acid, sulfuric acid, sodium sulfate and mixtures thereof. When etching is used as the surface pretreatment, it is preferably carried out for at least about 2 mins, more preferably for about 2 to about 30 mins, and most preferably for about 5 to about 10 mins. Etching is preferably carried out at a temperature of from about 15° C. to about 95° C., more preferably from about 20° C. to about 60° C., most preferably from about 25° C. to about 30° C. Preferably etching would be carried out prior to catalysis and acceleration.

The catalyst for use according to the present invention is preferably selected from palladium, SnCl₂, hydrochloric acid, and mixtures thereof. Commercially available catalysts include CATAPREP 44™ and CATAPOSIT™. The temperature of the catalysis is preferably about room temperature, more preferably between about 20° C. and about 95° C., most preferably between about 30° C. and about 60° C., and most preferably between about 40° C. and about 50° C. Catalysis is preferably carried out for at least about 2 mins, more preferably for at least about 5 mins., and most preferably for at least about 10 mins.

Catalysis is often followed by acceleration to remove tin complex species from the catalyst film. Preferred accelerators include solutions of ammonium bifluoride or fluoride free solutions, such as alkane sulfonic acid solutions. Commercially available accelerators can be obtained, for example, under the tradename ACCELERATOR 241™ Acceleration is preferably carried out at a temperature of about 10° C. to about 95° C., more preferably at a temperature of about 15° C. to about 40° C., most preferably at a temperature of about 20° C. to about 30° C. Acceleration is preferably carried out for at least about 1 mins, more preferably at least about 5 mins, most preferably at least about 15 mins.

The surface may be neutralized after etching and prior to catalysis. Neutralizing of surfaces follows etching in strong acids and is intended to reduce residual oxidative acid from the etching solution. Neutralizing is used to prevent the introduction of contamination from the etching solution into the catalysis solution. Preferred neutralizing agents include sulfuramine compounds, which can be purchased under the tradename Neutralizer PM 954™. Neutralizing is preferably carried out at a temperature of from about 10° C. to about 95° C., more preferably from about 20° C. to about 50° C. Neutralizing is preferably carried out for at least about 1 min., more preferably at least about 5 mins., most preferably at least about 10 mins.

Adhesion of the plated coating can be affected by the times and temperatures of the various pretreatment steps. Appropriate pretreatment to optimize coating adhesion will be readily apparent to the skilled artisan depending upon the composition of the elastomeric mantel of the roll and the composition of the wear-resistant coating.

The wear-resistant coating is then applied to the prepared surface. One preferred method of applying the wear-resistant surface is through a plating process. The preferred plating process can be used with a variety of materials that are art recognized and would be readily apparent to the skilled artisan. The preferred plating process has been described based upon a nickel plating process, however, this invention is in no way limited to plating or more particularly, nickel plating. Other plating processes based on copper salts dissolved in a mixture of sodium hydroxide and formaldehyde, or based on a combination of silver salts dissolved in, for example, potassium hydroxide and nitric acid.

When nickel plating is used, caustic plating is generally carried out before auto catalytic deposition of nickel or electroplating of chrome, nickel, steel, Teflon, nitrides, carbides, indium, phosphor, molybdenum sulfites and alloys and mixtures thereof. The plating process can include one or more steps and they may be any combination of caustic and acidic plating steps.

Caustic nickel plating is preferably carried out using nickel salt in a caustic solution such as ammonium hydroxide. Preferred temperatures for caustic electroless nickel plating are less than about 95° C., more preferably, the plating process is carried out a temperature between 50° C. and 60° C. Deposition is preferably carried out for at least about 2 mins, more preferably for at least about 10 mins, and most preferably for at least about 15 mins.

As an alternative to caustic nickel plating according to one embodiment of the present invention, a boron based system may be used to deposit nickel directly onto a palladium activated surface. More particularly, an electroless nickel coating with superior hardness and wear may be generated from a system in which sodium-borhydrate or an alkyaminboron are used as the reducing agent. Preferred reducing agents include, sodiumborhydrate, methylaminboron and ethylaminboron. Preferred temperatures for this boron based deposition system are preferably between about 65° C. and 95° C., more preferably between about 80° C. and 90° C. The boron content of the nickel coating is preferably between about 0.1% and about 5%.

Acidic auto catalytic nickel plating is preferably carried out under conditions resulting in a phosphor content between 1% and 13%, more preferably between 5% and 9%. Preferred temperatures for acidic electroless nickel plating are less than about 100° C., more preferably, the plating process is carried out at temperatures between 85° C. and 95° C. Deposition rate is affected by the temperature at which the deposition is carried out. Deposition rate increases with increases in temperature. Deposition is preferably carried out for at least about 20 mins, more preferably for at least about 60 mins, and most preferably for at least about 120 mins.

In one preferred embodiment, acidic electroless nickel plating is preferably carried out following caustic electroless nickel plating. The acidic plating may be from immediately following the caustic deposition until weeks after the caustic nickel plating. If the acidic deposition is delayed, the nickel coating may be reactivated in a variety of acidic solutions with or without an external power supply. The caustic nickel may be reactivated in solutions containing sulfuric acid, nitric acid, hydrofluoric acid, ferric sulfate and mixtures thereof. The selection of appropriate activation conditions would be readily apparent to the skilled artisan.

Preferred coating depths are less than about 250 μm, more preferably less than 125 μm, and most preferably less than about 80 μm.

The wear-resistant coating may be heat treated to improve the microhardness of the coating layer. Heat treatment must be carried out at a temperature below that deformation temperature of the roll substrate material. Appropriate heat treatments would be readily apparent to the skilled artisan depending upon the composition of the roll substrate and the composition of the wear-resistant coating. Heat treatment is preferably carried out at a temperature of between about 200° C. and about 400° C., more preferably at temperature of between about 250° C. and about 400° C., and most preferably at a temperature of between about 300° C. and about 400° C. The heat treatment is between about 1 hour and 24 hours, more preferably between about 2 hours and 16 hours and most preferably about 4 hours and 12 hours.

Embodiments of the present invention will now be described by way of example. The following examples are in no way limiting of the present invention which is defined in the appended claims.

### EXAMPLES

### Example 1

A nitrile rubber sample was cleaned in acetone by immersion for 5 minutes. After rinsing, the surface was catalyzed for 7 minutes at 55° C. (+/−5° C.). After catalysis, the surface was accelerated for 7 minutes at room temperature (20° C.-25° C). The surface was subjected to caustic electroless nickel for between 15 and 20 minutes at 60° C. (+/−50° C.) and then was subjected to acidic electroless nickel at a temperature between 75° C. and 80° C. A nickel plating of 25 μm was formed in about 60 minutes. See Table 1, below.

### Example 2

A sample of VAL COAT PLUS™ was roughened with sand paper and then cleaned by immersion in acetone for 5 minutes. The surface was then etched in chromic acid for approximately 5 minutes and then neutralized for 5 minutes in a solution of NEUTRALIZER PM-954™. The surface was catalyzed for 7 minutes and then accelerated for 7 minutes. The surface was then subjected to caustic electroless nickel for 15-20 minutes at 55° C. (+/−5° C.). See Table 1, below.

### Example 3

A sample of TOP ROCK RESIN™ was cleaned by immersion in acetone for 5 minutes. The surface was then etched with chromic acid for 10 to 15 minutes at room temperature (20° C.-25° C.) and neutralized with NEUTRALIZER PM-954™ for 10 minutes. The surface was catalyzed for 7 minutes at 55° C. and then accelerated for 7 minutes at room temperature. The surface was then subjected to caustic electroless nickel for between 15 and 20 minutes at 60° C. Finally, the surface was subjected to acidic electroless nickel at temperatures from 80° C. and 90° C. See Table 1, below.

### Example 4

A sample of PREMIUM ROCK™, Ebonite was mechanically roughened with sand paper and cleaned by immersion in acetone for 5 minutes. The surface was then etched with chromic acid for 10 to 15 minutes at room temperature (20° C.-25° C.) and neutralized with NEUTRALIZER PM-954™ for 10 minutes. The surface was catalyzed for 7 minutes at 55° C. and then accelerated for 7 minutes at room temperature. The surface was then subjected to caustic electroless nickel for between 15 and 20 minutes at 55° C. Finally, the surface was subjected to acidic electroless nickel at temperatures from 80° C. and 90° C.

It has been noted that acetone visually etched the surface. Chromic acid, while changing the surface conditions did not result in visible surface changes of the substrate. See Table 1, below. In Table 1, the ratio 1.0 refers to samples that achieved good adhesion.

TABLE 1

| | Cleaning | Neutralizing | Catalyzing | Accelerating | Caustic | Acidic | |
|---|---|---|---|---|---|---|---|
| Example | mins. | mins. | mins. | mins. | EN | EN | Rating |
| 1 | 5 | — | 7 | 7 | 15-20 | 40 | 1.0 |
| 2 | 5 | 5 | 7 | 7 | 15-20 | — | 1.0 |
| 3 | 5 | 10 | 7 | 7 | 15-20 | 30 | 1.0 |
| 4 | 5 | 10 | 7 | 7 | 15-20 | 30 | 1.0 |

### Examples 5-13

The following examples were carried out on nitrile rubber to review the adhesion properties of nickel plating. All examples were carried out using the procedure noted with changes as indicated in Table 2, below. The nitrile rubber sample was first etched in 750 g CrO₃ and 150 ml of concentrated H₂SO₄ adjusted with deionized water to 1500 ml. Etching was carried out at a temperature of 20° C. to 25° C. under moderate stirring conditions. Following the etching step, the sample was rinsed twice with deionized water. The sample was then neutralized with 38 ml of PM 954™, 150 ml of concentrated hydrochloric acid and 1312 ml of deionized water. Neutralization was carried out at a temperature of 20° C. to 25° C. under moderate stirring conditions. After being neutralized, the sample was again rinsed in deionized water.

The sample was then subjected to a catalyst solution containing 30 ml CATAPREP 44™, 300 ml of concentrated hydrochloric acid and 1170 ml of deionized water. Catalysis was carried out at a temperature of 38° C. to 50° C. under moderate stirring conditions. After being catalyzed, the sample was again rinsed in deionized water. The sample was then subjected to acceleration. The solution used included 150 ml of ACCELERATOR 241™, and 1320 ml of deionized water. Acceleration was carried out at a temperature of 20° C. to 25° C. under moderate stirring conditions. After being accelerated, the sample was again rinsed in deionized water.

Finally, the sample was plated with nickel using a plating solution containing 209 ml of PM 980™, 1250 ml of deionized water and 41 ml of NH₄OH. Plating was carried out at a temperature of 60° C. to 65° C and at a pH of 8.5 to 9.5. Plating was carried out under moderate stirring conditions for a time of 30 minutes.

TABLE 2

| | Etching | Neutralize | Catalyze | Accelerate | Adhesion |
|---|---|---|---|---|---|
| Experiment | min | min | min | min | 1 = 100% |
| 1 | 2.00 | 2.00 | 4.00 | 3.00 | 0.80 |
| 2 | 2.00 | 4.00 | 6.00 | 5.00 | 1.00 |
| 3 | 2.00 | 6.00 | 8.00 | 7.00 | 0.20 |
| 4 | 5.00 | 2.00 | 6.00 | 7.00 | 1.00 |
| 5 | 5.00 | 4.00 | 8.00 | 3.00 | 0.00 |
| 6 | 5.00 | 6.00 | 4.00 | 5.00 | 0.60 |
| 7 | 10.00 | 2.00 | 8.00 | 5.00 | 0.20 |
| 8 | 10.00 | 4.00 | 4.00 | 7.00 | 0.00 |
| 9 | 10.00 | 6.00 | 6.00 | 3.00 | 0.20 |

### Examples 14-21

Eight samples were tested for wear resistance. The substrate and wear-resistant coating are as noted in the table. ISO 8251 provides a reasonable indication of how samples will work during actual commercial use. These examples establish the improvement in wear resistance when the substrate is provided with a wear-resistant coating. The addition of Teflon to the wear-resistant coating further improved the durability.

TABLE 3

| | | | Double | Weight | |
|---|---|---|---|---|---|
| Sam- | Nickel | | Strokes (DS) | Difference | Wear |
| ple | Plating | Substrate | of ISO 8251 | (g) | mg/1000 DS |
| 1 | No | PREMIUM | 800 | 0.0821 | 103 |
| | | ROCK ™ | | | |
| 2 | No | VAL-COAT | 800 | 0.0762 | 95 |
| | | PLUS ™ | | | |
| 3 | Yes | PREMIUM | 800 | 0.0295 | 37 |
| | | ROCK ™ | | | |
| 4 | Yes | VAL-COAT | 800 | 0.0426 | 53 |
| | | PLUS ™ | | | |
| 5 | Yes with | TOP | 311 | 0.0128 | 32 |
| | Teflon | ROCK ™ | | | |
| 6 | Yes | TOP | 400 | 0.0188 | 47 |
| | | ROCK ™ | | | |
| 7 | Yes | VAL-COAT | 400 | 0.0180 | 45 |
| | | PLUS ™ | | | |
| 8 | No | TOP | 800 | 0.0476 | 60 |
| | | ROCK ™ | | | |
| 9 | No | PREMIUM | 400 | 0.0467 | 117 |
| | | ROCK ™ | | | |
| 10 | Yes With | TOP | 200 | 0.0129 | 27 |
| | Teflon | ROCK ™ | | | |
| 11 | No | Rubber | 400 | 0.0353 | 89 |
| | | Nitrile | | | |
| 12 | No | PREMIUM | 400 | 0.0478 | 120 |
| | | ROCK ™ | | | |

### Example 22

The following prophetic example describes one embodiment in which a core/metallic mantel can be patterned and refurbished.

A steel roll is plated with a thick layer, 25 to 500 μm, of copper or zinc. The plated surface is machined to the desired dimension. If the roll has been copper plated, a zinc plating is applied prior to laser engraving.

The zinc surface is laser engraved to the desired emboss pattern and the surface is covered with a thin layer, approximately 50 μm of a wear resistant material, for example, plated hard chrome. Surface pretreatment and the like can be used and would be readily apparent to the skilled artisan. The roll is now ready to be used to emboss a paper product.

Once the roll has been used and either a new pattern is desired or unacceptable wear has occurred, the chrome is chemically stripped from the roll. The surface is then machined and polished. Once polished, the surface can again be plated with a zinc coating to return the roll to its original, or desired dimensions. The engraving and use process may now be repeated.

As an alternate to use of the steel roll described above, a sleeve can be prepared which will be mounted to the steel core. The sleeve may be produced of, for example, aluminum.

The following prophetic example describes one embodiment in which a core may have a patternable cast metallic surface.

To the outside of a steel core is cast a metallic coating of, for example, aluminum or zinc. The cast coating can be machined to the desired dimension and is then subjected to laser engraving to impart the desired emboss pattern. The surface may then, if desired, be covered with a wear resistant surface coating. When plating an aluminum surface with, for example, electroless nickel as a wear resistant surface, a zincate process is generally required prior to nickel deposition. The zinc acts as a primer.

As discussed above, once spent, the surface may be stripped and then plated to its original dimensions. The process can then be carried out again.

As an alternative to applying a wear resistant coating, an aluminum surface may be hard anodized, to a thickness of, for example, 2 mils. The hardness of the anodized layer with by approximately 450 to 500 HV, which is approximately twice the hardness of hard chrome. The abrasive wear resistance of aluminum is, however, only generally comparable to hard chrome.

Anodizing of aluminum is well understood in the art and is generally carried out using sulfuric acid treatments which may eventually contain small amounts of other acids, for example, oxalic acid. Any art recognized aluminum anodizing process may be used according to the present invention.

### Example 24

A roll can be made as in Example 22 except that a nickel surface may be used in place of the zinc or copper surface. Very thick nickel coatings on the order of 25 μm to 500 μm, can be plated using a high speed nickel sulfamate process. Since such a nickel plating is softer than electroless nickel, after laser engraving of the nickel, it is preferable to coat the nickel with a wear resistant surface.

### Example 25

A roll can be prepared in accordance with either Example 22 or Example 23 using a zinc surface that is plated or cast. The zinc surface is patterned by laser engraving and then coated with a wear resistant coating of electroless nickel. The roll is then heated to a temperature of from about 300° C. to about 400° C. to improve wear performance. Recrystallization of the nickel surface at these elevated temperatures results in increased hardness and wear resistance. A roll according to this example may be refurbished as described in Example 22.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An embossing roll comprising:
a structurally rigid core, a laser engravable surface, and a wear-resistant coating.

2. The embossing roll of claim 1, wherein the laser engravable material is formed of a material selected from at least one of rubber, silicone rubber, nylon, polyesters, polyurethane, polytetrafluoroethylene, polyvinylidene fluoride co-hexafluoropropylene, nitrile rubbers, ebonite, epoxy resin, phenolic resin, polyester resin, thermosetting resin, polycarbonate resin, aluminum, cast aluminum, brass, bronze, nickel, chrome, cast iron, steel, stainless steel, zinc, tin, alloys and mixtures thereof.

3. The embossing roll of claim 1, wherein the metallic wear-resistant plated coating is selected from nickel, chrome, steel, alloys and mixtures thereof with or without the addition of wear improving compounds Teflon, carbides, nitrides, silicates, diamonds, indium, molybdenum sulfide, phoshphor, boron, or mixtures thereof.

4. The embossing roll of claim 1, wherein the wear-resistant plated coating is nickel with phosphorus.

5. The embossing roll of claim 1, wherein said laser engravable surface is patterned using laser engraving.

6. The embossing roll of claim 1, wherein said laser engravable surface and said structurally rigid core are the same material.

7. The embossing roll of claim 6, wherein the material is selected from at least one of aluminum, brass, bronze, nickel, chrome, cast iron, steel, zinc, tin, alloys and mixtures thereof.

8. The embossing roll of claim 1, wherein the laser engravable surface is cast over the structurally rigid core.

9. The embossing roll of claim 8, wherein the material is selected from at least one of aluminum, brass, bronze, nickel, chrome, cast iron, steel, zinc, tin, alloys and mixtures thereof.

10. The embossing roll of claim 1, wherein the laser engravable surface is plated over the structurally rigid core.

11. The embossing roll of claim 10, wherein the material is selected from at least one of aluminum, brass, bronze, nickel, chrome, cast iron, steel, zinc, tin, alloys and mixtures thereof.

12. An embossing roll comprising:
a core;
an elastomeric patternable material surrounding said core; and
a metallic wear-resistant plated coating surrounding said core.

13. The embossing roll of claim 12, wherein the elastomeric patternable material core is selected from rubber, silicone rubber, nylon, polyesters, polyurethane, polytetrafluoroethylene, polyvinylidene co-hexafluoropropylene, nitrile rubbers, ebonite, epoxy resin, phenolic resin, polyester resin, thermosetting resin and polycarbonate resin.

14. The embossing roll of claim 12, wherein the metallic wear-resistant plated coating is selected from nickel, chrome, steel, Teflon, carbide, nitride, diamonds, silicate, molybdenum sulfide, phosphor, boron, indium and mixtures thereof.

15. The embossing roll of claim 12, wherein the wear-resistant plated coating is nickel with phosphorus.

16. The embossing roll of claim 12, wherein said elastomeric material is patterned using laser engraving.

17. The embossing roll of claim 12, wherein said core is selected from an elastomeric material, steel, chrome, nickel, aluminum, ceramic and mixtures thereof.

18. A method of making an embossing roll comprising:
providing a structurally rigid core;
providing a laser engravable surface;
patterning said laser engravable surface with an embossing pattern; and
plating said laser engraved surface with a metallic wear-resistant material.

19. The method of claim 18, wherein the laser engravable surface is formed of a material selected from at least one of rubber, silicone rubber, nylon, polyesters, polyurethane, polytetrafluoroethylene, polyvinylidene fluoride co-hexafluoropropylene, nitrile rubbers, ebonite, epoxy resin, phenolic resin, polyester resin, thermosetting resin, polycarbonate resin, aluminum, cast aluminum, brass, bronze, nickel, chrome, cast iron, steel, stainless steel, zinc, tin, alloys and mixtures thereof.

20. The method of claim 18, wherein the metallic wear-resistant plated coating is selected from nickel, chrome, steel, alloys and mixtures thereof with or without the addition of wear improving compounds Teflon, carbides, nitrides, silicates, diamonds, indium, molybdenum sulfide, phosphor, boron, or mixtures thereof.

21. The method of claim 18, wherein the wear-resistant plated coating is nickel with phosphor.

22. The method of claim 18, wherein said patterning is laser engraving.

23. The method of claim 18, wherein the laser engravable surface and the structurally rigid core are a unitary material.

24. The method of claim 23, wherein the material is selected from at least one of aluminum, brass, bronze, nickel, chrome, cast iron, steel, zinc, tin, alloys and mixtures thereof.

25. The method of claim 18, wherein the laser engravable surface is cast over the structurally rigid core.

26. The method of claim 25, wherein the material is selected from at least one of aluminum, brass, bronze, nickel, chrome, cast iron, steel, zinc, tin, alloys and mixtures thereof.

27. The method of claim 18, wherein the laser engravable surface is plated over the structurally rigid core.

28. The method of claim 27, wherein the material is selected from at least one of aluminum, brass, bronze, nickel, chrome, cast iron, steel, zinc, tin, alloys and mixtures thereof.

29. A method of making an embossing roll comprising:
providing a core;
surrounding said core with an elastomeric material;
patterning said elastomeric material with an embossing pattern; and
plating said patterned core with a metallic wear-resistant material.

30. The method of claim 29, wherein the elastomeric material is formed of a material selected from rubber, silicone rubber, nylon, polyesters, polyurethane, polytetrafluoroethylene, polyvinylidene fluoride co-hexafluoropropylene, nitrile rubbers, ebonite, epoxy resin, phenolic resin, polyester resin, thermosetting resin or polycarbonate resin.

31. The method of claim 29, wherein the metallic wear-resistant material is selected from nickel, chrome, steel, alloys and mixtures thereof with or without the addition of wear improving compounds Teflon, carbides, nitrides, silicates, diamonds, indium, molybdenum sulfide, phoshpor, boron, or mixtures thereof.

32. The method of claim 29, wherein the wear-resistant material is nickel with phosphor.

33. The method of claim 29, wherein said patterning is laser engraving.

34. A laser engravable sleeve for an embossing roll comprising:
a sleeve of a laser engravable material, and a wear resistant coating.
